(19) United States
(12) Patent Application Publication
(10) Pub. No.: US 2026/0312713 A1
(43) Pub. Date: Oct. 8, 2026

(54) CLOCK FORWARDING IN PACKAGED OPTICS LINKS

(71) Applicant: Lightmatter, Inc., Mountain View, CA (US)

(72) Inventors: Darius Bunandar, Boston, MA (US); Carlos Dorta-Quinones, Medford, MA (US); Anthony Kopa, Somerville, MA (US); Alexander Sludds, Cambridge, MA (US); Bradford Turcott, Georgetown, TX (US); Sriram Venkatesan, Fremon, CA (US); Joyce Poon, Toronto (CA); Rishi Anand, Nobleton (CA); Vibha Prakash Goel, Saratoga, CA (US); Pierre-Luc Cantin, Palo Alto, CA (US)

(73) Assignee: Lightmatter, Inc., Mountain View, CA (US)

(21) Appl. No.: 19/638,818

(22) Filed: Apr. 3, 2026

Related U.S. Application Data
(60) Provisional application No. 63/783,879, filed on Apr. 4, 2025.

(51) Int. Cl. H04J 14/02; G06F 1/10

(52) U.S. Cl. CPC H04J 14/02; G06F 1/10

(57) ABSTRACT

Conventional packaged optics systems recover clock from data signals using clock and data recovery circuitry, which introduces jitter. The recovered clock cannot perfectly track timing variations in the data signal because the recovery circuitry operates with finite bandwidth and response time. This timing misalignment reduces effective eye opening at the receiver and may require more powerful forward error correction schemes that consume additional power and introduce latency. The present disclosure addresses this problem by transmitting the clock on a dedicated wavelength channel through the same optical fiber as the data channels. Because the clock signal traverses the same optical medium and experiences similar propagation characteristics, the forwarded clock tracks jitter present in the data channels. This reduces effective jitter at the sampling instant and may eliminate gearbox circuitry otherwise required for rate conversion. These techniques may be applied to packaged optics architectures, including co-packaged optics and near-packaged optics configurations.

### CROSS-REFERENCE TO RELATED APPLICATIONS

This application claims the benefit of U.S. Provisional Application Ser. No. 63/783,879, filed on Apr. 4, 2025, under Attorney Docket No. L0858.70124US00 and entitled “CHIP-TO-CHIP (AKA DIE-TO-DIE) OPTICS LINK ARCHITECTURE,” which is hereby incorporated herein by reference in its entirety.

### BACKGROUND

Wavelength division multiplexing (WDM) is an optical communication technique that transmits multiple data streams simultaneously over a single optical fiber by using different wavelengths of light for each data stream. In a WDM system, multiple lasers generate optical signals at distinct wavelengths, and these signals are combined by a multiplexer onto a single fiber for transmission. At the receiving end, a demultiplexer separates the combined optical signal back into individual wavelength channels, directing each wavelength to a corresponding photodetector for conversion to electrical signals. WDM systems may operate in various bands, including the O-band (approximately 1260-1360 nm), C-band (approximately 1530-1565 nm), and L-band (approximately 1565-1625 nm), depending on the application and fiber characteristics. A WDM grid defines the wavelength or frequency spacing between adjacent channels in a WDM system. Tighter channel spacing enables higher aggregate bandwidth but may increase susceptibility to crosstalk between adjacent channels.

### SUMMARY

In some aspects, the techniques described herein relate to a package, including: an electronic integrated circuit (EIC) configured to obtain, from a processing unit co-packaged with the EIC, a data stream and a clock signal; and a photonic integrated circuit (PIC), on which the EIC is mounted, configured to: encode a plurality of data channels using the data stream obtained by the EIC from the processing unit, wherein encoding the plurality of data channels includes modulating light having wavelengths defining a wavelength division multiplexing (WDM) grid, encode a clock channel using the clock signal obtained by the EIC from the processing unit, wherein encoding the clock channel includes modulating light having a wavelength that is different from each of the wavelengths defining the WDM grid, transmit the modulated light having wavelengths defining the WDM grid through an optical fiber, and transmit the modulated light having the wavelength different from each of the wavelengths defining the WDM grid through the optical fiber.

In some aspects, the techniques described herein relate to a package, wherein the wavelength is positioned within a same communication band as the wavelengths defining the WDM grid.

In some aspects, the techniques described herein relate to a package, wherein the wavelength is positioned between adjacent wavelengths of the WDM grid.

In some aspects, the techniques described herein relate to a package, wherein the wavelength is positioned less than 1 THz away from the closest wavelength of the WDM grid.

In some aspects, the techniques described herein relate to a package, wherein the data stream obtained by the EIC from the processing unit has a transfer rate, and wherein modulating the light having wavelengths defining the WDM grid is performed at a modulation rate matching the transfer rate.

In some aspects, the techniques described herein relate to a package, wherein the EIC lacks a gearbox configured to perform rate conversion between the processing unit and the PIC.

In some aspects, the techniques described herein relate to a package, wherein the processing unit is coupled to the EIC through an I/O interface that conforms to a Universal Chiplet Interconnect Express (UCIe) protocol.

In some aspects, the techniques described herein relate to a package, further including a substrate on which the PIC and the processing unit are mounted, wherein the substrate includes a silicon bridge coupling the PIC to the processing unit.

In some aspects, the techniques described herein relate to a package, including: a photonic integrated circuit (PIC) configured to: receive, from an optical fiber, modulated light having wavelengths defining a wavelength division multiplexing (WDM) grid, receive, from the optical fiber, modulated light having a wavelength that is different from each of the wavelengths defining the WDM grid, extract a data stream from the modulated light having wavelengths defining the WDM grid, and extract a clock signal from the modulated light having the wavelength that is different from each of the wavelengths defining the WDM grid; and an electronic integrated circuit (EIC), mounted on the PIC, configured to: forward the data stream to a processing unit co-packaged with the EIC, and forward the clock signal to the processing unit.

In some aspects, the techniques described herein relate to a package, wherein the EIC lacks clock and data recovery (CDR) circuitry for recovering a clock from the data stream.

In some aspects, the techniques described herein relate to a package, wherein the wavelength is positioned within a same communication band as the wavelengths defining the WDM grid.

In some aspects, the techniques described herein relate to a package, wherein the wavelength is positioned between adjacent wavelengths of the WDM grid.

In some aspects, the techniques described herein relate to a package, wherein the wavelength is positioned less than 1 THz away from the closest wavelength of the WDM grid.

In some aspects, the techniques described herein relate to a package, wherein the data stream forwarded to the processing unit has a transfer rate, and wherein extracting the data stream from the modulated light is performed at a rate matching the transfer rate.

In some aspects, the techniques described herein relate to a package, wherein the EIC lacks a gearbox configured to perform rate conversion between the PIC and the processing unit.

In some aspects, the techniques described herein relate to a package, wherein the processing unit is coupled to the EIC through an I/O interface that conforms to a Universal Chiplet Interconnect Express (UCIe) protocol.

In some aspects, the techniques described herein relate to a method, including: obtaining, by a first electronic integrated circuit (EIC), a data stream and a clock signal from a first processing unit co-packaged with the first EIC; encoding, by a first photonic integrated circuit (PIC) on which the first EIC is mounted, a plurality of data channels using the data stream, wherein encoding the plurality of data channels includes modulating light having wavelengths defining a wavelength division multiplexing (WDM) grid; encoding, by the first PIC, a clock channel using the clock signal, wherein encoding the clock channel includes modulating light having a wavelength that is different from each of the wavelengths defining the WDM grid; transmitting, by the first PIC, the modulated light having wavelengths defining the WDM grid and the modulated light having the wavelength different from each of the wavelengths defining the WDM grid through an optical fiber; receiving, by a second PIC, the modulated light having wavelengths defining the WDM grid and the modulated light having the wavelength different from each of the wavelengths defining the WDM grid from the optical fiber; extracting, by the second PIC, the data stream from the modulated light having wavelengths defining the WDM grid; extracting, by the second PIC, the clock signal from the modulated light having the wavelength different from each of the wavelengths defining the WDM grid; forwarding, by a second EIC mounted on the second PIC, the data stream and the clock signal to a second processing unit co-packaged with the second EIC; and sampling, by the second processing unit, the data stream using the clock signal.

In some aspects, the techniques described herein relate to a method, wherein the wavelength is positioned within a same communication band as the wavelengths defining the WDM grid.

In some aspects, the techniques described herein relate to a method, wherein the second EIC lacks clock and data recovery (CDR) circuitry for recovering a clock from the data stream.

In some aspects, the techniques described herein relate to a method, wherein the data stream obtained by the first EIC from the first processing unit has a transfer rate, and wherein modulating the light having wavelengths defining the WDM grid is performed at a modulation rate matching the transfer rate.

### BRIEF DESCRIPTION OF FIGURES

Various aspects and embodiments of the application will be described with reference to the following figures. It should be appreciated that the figures are not necessarily drawn to scale. Items appearing in multiple figures are indicated by the same reference number in the figures in which they appear.

FIG. 1 illustrates a system diagram depicting two packages connected via an optical fiber link for chip-to-chip communication, according to aspects of the present disclosure.

FIG. 2A illustrates a cross-sectional view of a package for optical communication with a clock recovery architecture, according to aspects of the present disclosure.

FIG. 2B illustrates a block diagram of a transmit data path for a clock recovery optical communication system, according to aspects of the present disclosure.

FIG. 2C illustrates a block diagram of a receive data path for a clock recovery optical communication system, according to aspects of the present disclosure.

FIG. 2D depicts a timing diagram illustrating jitter in a clock recovery architecture, according to aspects of the present disclosure.

FIG. 3A illustrates a cross-sectional view of a package for optical communication with a clock forwarding architecture, according to aspects of the present disclosure.

FIG. 3B illustrates a block diagram of a transmit path for an optical communication system with clock forwarding, according to aspects of the present disclosure.

FIG. 3C illustrates a block diagram of a receive path for an optical communication system with clock forwarding, according to aspects of the present disclosure.

FIG. 4A depicts a wavelength diagram illustrating a spectral arrangement of data channels and a clock channel, according to aspects of the present disclosure.

FIG. 4B illustrates a block diagram of an optical communication system with a dedicated clock channel, according to aspects of the present disclosure.

### DETAILED DESCRIPTION

Conventional packaged optics communication systems, such as co-packaged optics (CPO)-to-CPO or near-packaged optics (NPO)-to-NPO configurations, recover the clock at the receiver from the data signal using clock and data recovery (CDR) circuitry. In such systems, the receiver extracts timing information from transitions in the incoming data stream to reconstruct a clock signal for sampling the data. This approach presents several drawbacks that limit system performance and increase implementation complexity.

A first drawback of recovering the clock from the data signal relates to jitter accumulation and its effect on bit error rate (BER). The recovered clock cannot perfectly track the timing variations present in the data signal because the CDR circuitry operates with finite bandwidth and response time. As a result, the recovered clock exhibits jitter. This jitter manifests as timing uncertainty in the sampling instant, which reduces the effective eye opening at the receiver and degrades signal margin. Unbounded jitter components, such as those arising from power supply noise, may be particularly problematic because the CDR circuitry may not track these variations adequately. The resulting timing misalignment between the recovered clock and the data signal leads to increased BER, which may necessitate more powerful forward error correction (FEC) schemes that consume additional power and introduce latency.

A second drawback of conventional clock recovery approaches relates to the requirement for gearbox circuitry between the optical interface and downstream processing logic. The clock recovered from the data signal may not operate at the exact frequency required by the processing unit, such as an XPU. For example, the optical interface may operate at 64 Gbps non-return to zero (NRZ) while the processing logic may require data at a different rate compatible with the Universal Chiplet Interconnect Express (UCIe) 4-64 GT/s interface specification. A gearbox performs rate conversion to bridge this mismatch, buffering data and retiming the data stream to match the requirements of the downstream circuitry. The gearbox may also perform protocol conversion when the optical interface uses a different signaling protocol than the processing unit expects. The inclusion of gearbox circuitry adds complexity to the system architecture, increases latency in the data path, consumes additional power, and increases overall system cost. These penalties become more pronounced as data rates increase and as systems scale to support higher aggregate bandwidth.

Recognizing these limitations, the inventors have developed schemes that transmit the clock on a dedicated wavelength channel through the same optical fiber as the data channels. Rather than recovering the clock from the data signal at the receiver, the clock is forwarded from the transmitter to the receiver on a dedicated wavelength, denoted as λ_{clock}. The clock wavelength is transmitted alongside the data wavelengths through the optical fiber, with the clock signal modulated onto the dedicated clock wavelength at the transmitter and demodulated at the receiver.

The clock wavelength may be positioned in the same communication band (e.g., in the O-band, C-band or L-band) as the data wavelengths to minimize differences in group velocity between the clock channel and the data channels. By positioning the clock wavelength near the WDM grid, the propagation delay experienced by the clock signal closely matches the propagation delay experienced by the data signals. This arrangement preserves the temporal relationship between the clock and data as the signals traverse the optical fiber, maintaining timing alignment at the receiver.

At the receiver, the forwarded clock is extracted from the dedicated clock wavelength and provided to a phase-locked loop (PLL). The PLL conditions the received clock signal and provides timing for sample and decision circuitry that processes the received data signals. Because the clock signal traverses the same optical fiber as the data signals, the forwarded clock experiences similar propagation characteristics and timing variations as the data channels. The forwarded clock tracks the data through the fiber, enabling the receiver to sample the data signals at timing instants that account for jitter present in the data channels. This tracking capability reduces the effective jitter observed at the sampling instant, improving the eye opening at the receiver and increasing signal margin. Unbounded jitter components, such as those arising from power supply noise, are tracked by the forwarded clock because the clock signal experiences the same perturbations as the data signals. The reduction in effective jitter translates to improved bit error rate performance, which may enable the use of less powerful forward error correction schemes that consume less power and introduce less latency.

The forwarded clock architecture may eliminate (or at least simplify) gearbox circuitry that would otherwise be required to convert between different lane rates or to perform protocol conversion. Because the clock is forwarded directly from the transmitter to the receiver, the receiver operates with a clock that is inherently synchronized to the transmitter timing. This synchronization removes the need for rate conversion circuitry and buffering that conventional systems employ to bridge timing mismatches between the recovered clock and downstream processing logic. The elimination (or simplification) of gearbox circuitry reduces system complexity, decreases latency in the data path, lowers power consumption, and reduces overall system cost.

The clock forwarding schemes described herein may be used with different packaged optics configurations, including co-packaged optics (CPO) and near-packaged optics (NPO), for example. In CPO configurations, the photonic integrated circuit is integrated within the same package as the processing unit, with the optical components positioned in close proximity to the electronic components. In NPO configurations, the photonic integrated circuit is positioned near the processing unit but may be located in a separate package or module that is closely coupled to the processing unit package. Both CPO and NPO configurations may benefit from clock forwarding because the dedicated clock wavelength channel provides jitter tracking and synchronization capabilities regardless of the specific packaging arrangement.

The clock forwarding architecture may support a clock-only idle mode for power management. In this low-power link state, the data channels are powered down while the clock channel remains active. The receiver maintains lock on the forwarded clock signal during the idle period, which enables fast wake-up when data transmission resumes. Because the receiver does not need to re-acquire clock synchronization, the link can transition from idle to active operation with minimal latency. This clock-only idle mode is valuable for datacenter workloads with bursty traffic patterns, where links may experience periods of inactivity between bursts of data transfer.

The clock forwarding architecture may support bidirectional clock forwarding for full-duplex operation. In this configuration, both ends of the link transmit a forwarded clock signal, and each receiver uses the remote clock for sampling incoming data. This bidirectional arrangement provides symmetric jitter tracking for data flowing in both directions. The bidirectional clock forwarding scheme may be used in single-fiber bidirectional (BiDi) communication, where data signals traveling in opposite directions share the same fiber using different wavelength bands or time-division multiplexing.

In multi-fiber configurations, a shared clock wavelength may be distributed across multiple parallel fibers. A single clock laser and transmitter, combined with a clock distribution network, may feed the same clock signal to multiple parallel fibers. Each fiber carries independent data channels along with the distributed clock channel. When multiple fibers terminate at the same destination and the clock signal in each fiber originates from the same transmitter, the receiver may average the phase of multiple recovered clocks from the multiple fibers. This multi-fiber clock averaging reduces jitter beyond what is achievable with a single fiber, because uncorrelated noise components across the multiple fibers tend to cancel when averaged.

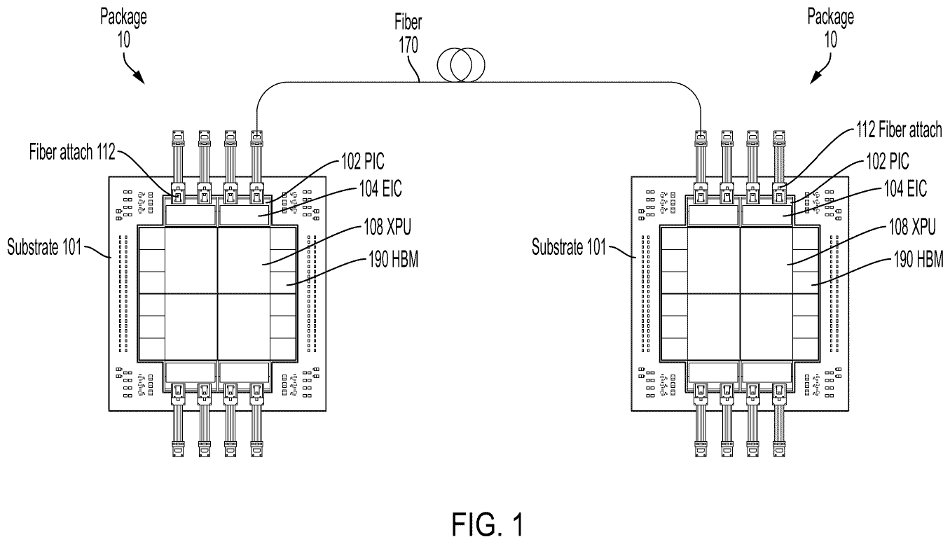

Referring to FIG. 1, a system diagram depicts two packages 10 connected via an optical fiber link for chip-to-chip communication. Each package 10 includes a substrate 101 upon which various components are mounted. The substrate 101 provides structural support and electrical connectivity for the components within each package 10. Photonic integrated circuits (PICs) 102 are positioned near the perimeter of each substrate 101. Each PIC 102 interfaces with fiber attach 112 components that provide physical connection points for optical fibers. The fiber attach 112 components are shown as multiple connectors extending from a top edge of each PIC 102, enabling coupling of optical signals between the optical fiber and the PIC 102. An electronic integrated circuit (EIC) 104 is positioned on top of each PIC 102.

Each package 10 further includes an XPU 108, which represents a processing unit such as a central processing unit (CPU), graphics processing unit (GPU), tensor processing unit (TPU), or other accelerator. The XPU 108 is positioned adjacent to the PIC 102 and the EIC 104 on the substrate 101. High bandwidth memory (HBM) 190 modules are arranged around the XPU 108 on the substrate 101, providing memory resources for the processing unit. The HBM 190 modules are shown as multiple stacked memory units distributed on the substrate 101, enabling high-bandwidth memory access for the XPU 108. A fiber 170 connects the two packages 10, enabling optical communication between the packages 10. The PICs 102 on each package 10 handle optical-to-electrical and electrical-to-optical conversion, with the fiber attach 112 components facilitating coupling of optical signals between the fiber 170 and the PIC 102. This configuration allows the XPU 108 in one package 10 to communicate with the XPU 108 in another package 10 through the optical link, with the HBM 190 providing local memory access for each respective XPU 108.

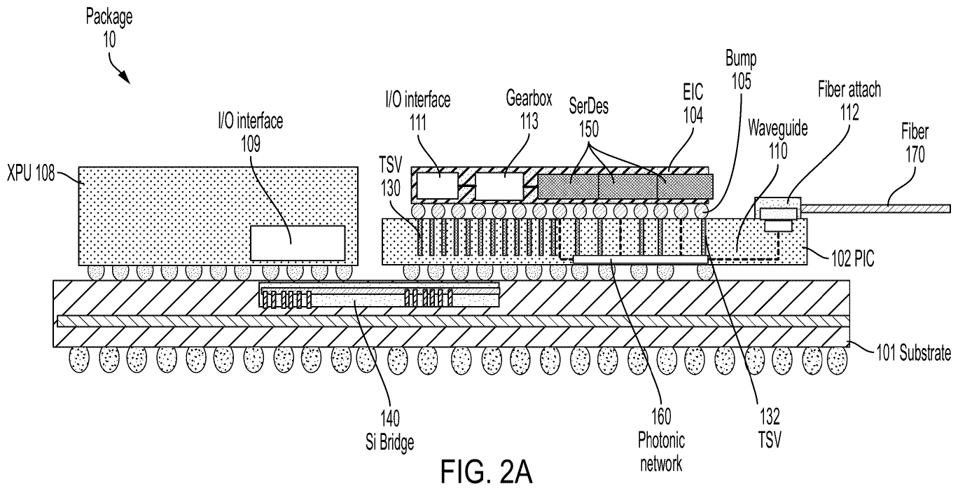

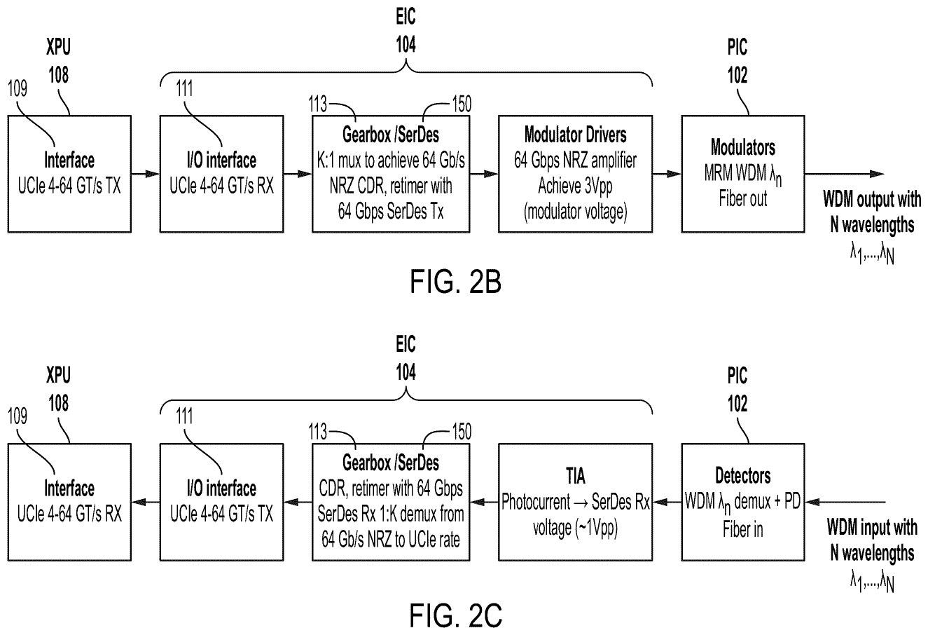

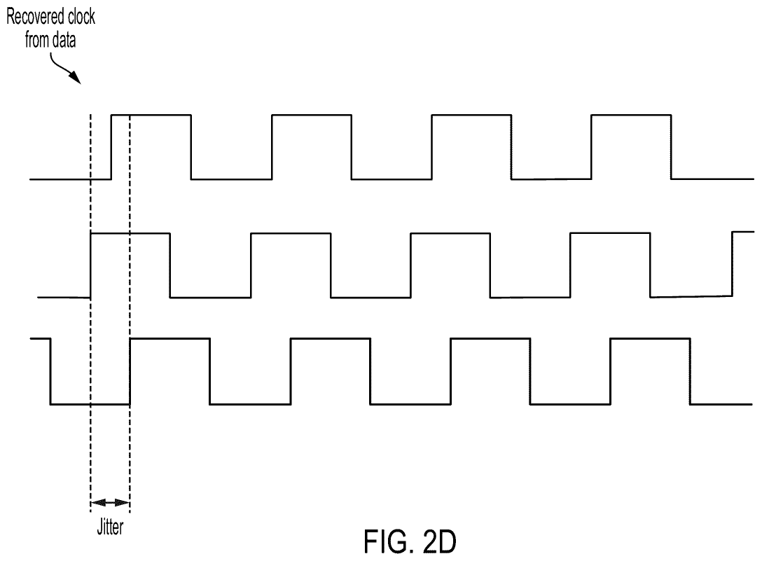

Referring to FIG. 2A, a cross-sectional view illustrates the architecture of a package 10 for optical communication with a clock recovery architecture. The package 10 includes the substrate 101 that provides structural support and electrical connectivity for components within the package 10. The PIC 102 is positioned on the substrate 101 and includes a photonic network 160 for optical signal switching and routing. The PIC 102 incorporates a waveguide 110 for guiding optical signals between components of the photonic network 160. The fiber attach 112 couples the PIC 102 to the fiber 170, enabling optical signals to be transmitted to and received from external systems through the fiber 170.

An EIC 104 is mounted on the PIC 102. The XPU 108 is co-packaged with the EIC 104 on the substrate 101. The EIC 104 contains multiple serializer/deserializer (SerDes) 150 units for serialization and deserialization of data. The EIC 104 also includes a gearbox 113 positioned adjacent to the SerDes 150 units. The gearbox 113 performs rate conversion between the optical interface and downstream processing logic. For example, the gearbox 113 may include a K:1 multiplexer that converts the slow-wide baud rate of the I/O interface 111 to match the baud rate of the SerDes 150, and a 1:K demultiplexer that performs the reverse function. As an example, the optical channel may operate at 64 Gbps non-return to zero (NRZ) while the processing logic may require data at a different rate compatible with the Universal Chiplet Interconnect Express (UCIe) 4-64 GT/s interface specification. The gearbox 113 performs the rate conversion. The SerDes 150 typically performs clock and data recovery (CDR) and retiming functions in this architecture.

The EIC 104 connects to the PIC 102 through bumps 105, which provide electrical interconnection between the EIC 104 and the PIC 102. The bumps 105 may have a pitch of 45 micrometers for microbump interconnection between the EIC 104 and the PIC 102. In some cases, the bumps 105 may have a pitch of 55 micrometers arranged in a checkerboard pattern for interconnection between the EIC 104 and the PIC 102. As an alternative to the bumps 105, the EIC 104 and the PIC 102 may be interconnected using a hybrid bonding interface (HBI).

The EIC 104 includes an I/O interface 111 for communication with other components within the package 10. The XPU 108 is positioned adjacent to the EIC 104 on the substrate 101. The XPU 108 includes an I/O interface 109 for data exchange with the EIC 104. The XPU 108 communicates with the PIC 102 through a silicon bridge (Si bridge) 140 embedded within the substrate 101. The Si bridge 140 provides high-density electrical routing between the XPU 108 and the PIC 102, enabling high-bandwidth communication between the processing unit and the optical interface. The I/O interface 109 and the I/O interface 111 may conform to Universal Chiplet Interconnect Express (UCIe) protocol for die-to-die communication. In some cases, the I/O interface 109 and the I/O interface 111 may be implemented using Bunch of Wires (BoW) or other die-to-die (D2D) interface protocols.

As further shown in FIG. 2A, through-silicon vias (TSVs) provide vertical electrical connections through the various layers of the package 10. A TSV 130 and a TSV 132 enable signal and power distribution between the substrate 101 and the components mounted thereon. The TSV 130 and the TSV 132 provide low-inductance vertical interconnections that support high-frequency signaling between the substrate 101 and the EIC 104 or the PIC 102. This arrangement allows for high-bandwidth optical communication between the XPU 108 and external systems through the photonic network 160.

Referring to FIG. 2B, a block diagram illustrates a transmit data path for a clock recovery optical communication system. In the transmit path, the XPU 108 includes the I/O interface 109 configured for UCIe 4-64 GT/s operation that provides data signals to the EIC 104. Within the EIC 104, the I/O interface 111 receives the data signals at UCIe 4-64 GT/s from the XPU 108. The I/O interface 111 forwards the data signals to the gearbox 113, which performs K:1 multiplexing to convert the slow-wide baud rate of the I/O interface 111 to match the baud rate of the SerDes 150, achieving 64 Gb/s NRZ output. The SerDes 150 performs CDR and retiming functions with 64 Gbps SerDes transmit capability and provides the serialized data to modulator drivers that amplify the signal to 64 Gbps NRZ and achieve 3 Vpp modulator voltage, for example. The modulator drivers connect to the PIC 102, which includes modulators implemented as microring modulators (MRM) with WDM wavelength designation that modulate the data onto optical wavelengths λ₁ through λ_{N} for transmission through the fiber 170 as a WDM output.

Referring to FIG. 2C, a block diagram illustrates a receive data path for a clock recovery optical communication system. In the receive path, the PIC 102 includes detectors that receive WDM input from the fiber 170. The detectors perform WDM demultiplexing and photodetection (PD) to convert the optical signals to electrical signals. The detectors provide photocurrent signals to a transimpedance amplifier (TIA) within the EIC 104, which converts the photocurrent to a voltage signal. For example, the TIA may convert the photocurrent to a SerDes receive voltage of approximately 1 Vpp. The TIA output is provided to the SerDes 150, which performs CDR and retiming functions to recover the clock from the data signal. The SerDes 150 may operate at 64 Gbps SerDes receive capability. The gearbox 113 performs 1:K demultiplexing to convert from the SerDes baud rate (e.g., 64 Gb/s NRZ) to the I/O interface rate compatible with the UCIe 4-64 GT/s interface specification. The gearbox 113 output connects to the I/O interface 111 operating at UCIe 4-64 GT/s TX, which provides data signals to the XPU 108 through the I/O interface 109.

Referring to FIG. 2D, a timing diagram illustrates jitter in a clock recovery architecture of the type illustrated in FIGS. 2A-2C. The timing diagram depicts three waveforms arranged vertically, with each waveform representing the recovered clock at different time intervals. The top waveform shows the recovered clock as a series of square wave pulses transitioning between high and low states. The two waveforms positioned below the recovered clock waveform represent data signals at subsequent time intervals. The waveforms display varying timing relationships that result from the clock recovery architecture. In a clock recovery scheme, the receiver extracts timing information from transitions in the incoming data stream to reconstruct the clock signal. However, the reconstructed clock does not perfectly align with the data transitions because the clock and data recovery circuitry operates with finite bandwidth and response time.

As further shown in FIG. 2D, two vertical dashed lines extend downward through all three waveforms, indicating the jitter measurement, which represents the timing variation in the recovered clock across different time intervals. The jitter measurement quantifies the temporal uncertainty between the recovered clock edges. In clock recovery architectures, this jitter degrades signal margin at the receiver because the sampling instant does not consistently align with the center of the data eye. The timing diagram demonstrates how clock recovery schemes introduce timing uncertainty that limits system performance, particularly when unbounded jitter components are present in the data signal.

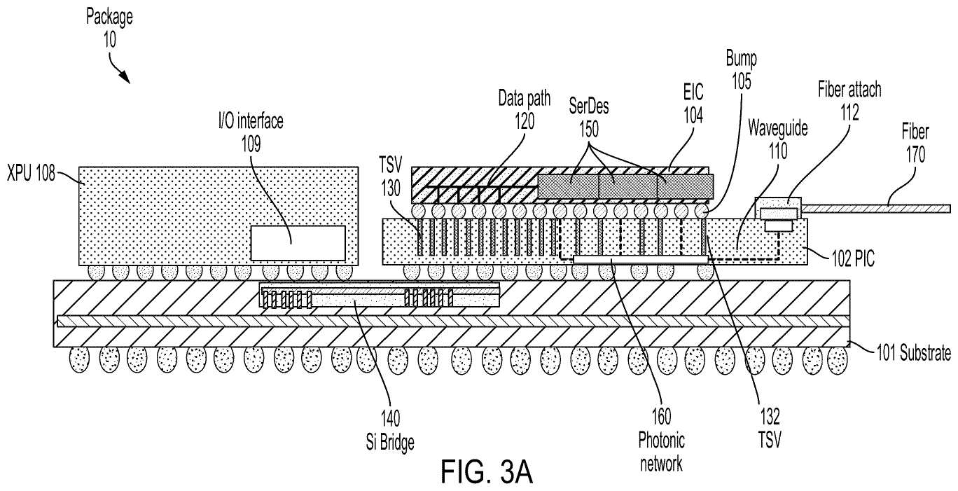

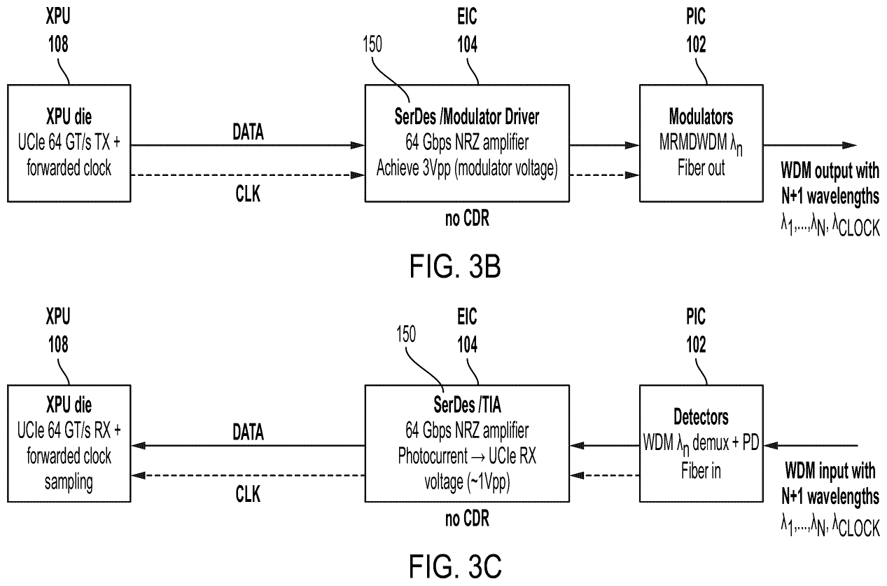

Recognizing these limitations, the inventors have developed schemes that forward the clock on a dedicated wavelength channel through the same optical fiber as the data channels. Referring to FIG. 3A, a cross-sectional view illustrates the architecture of the package 10 for optical communication with a clock forwarding architecture. The package of FIG. 3A is similar to the package of FIG. 2A in that it includes an XPU 108, an EIC 104 and a PIC 102. In contrast to the architecture of FIG. 2A, the clock forwarding architecture of FIG. 3A includes a data path 120 that provides signal routing between the SerDes 150 units and the XPU 108. The data path 120 replaces the I/O interface 111 and the gearbox 113 that are present in the clock recovery architecture. In the clock forwarding architecture, the optical modulation rate equals the data rate of the die-to-die interface between the XPU 108 and the EIC 104. For example, when the die-to-die interface conforms to the UCIe protocol operating at 64 GT/s, the optical modulation rate is also 64 Gbps NRZ. Similarly, when the die-to-die interface uses Bunch of Wires (BoW) or another die-to-die protocol, the optical modulation rate matches the corresponding interface data rate. This rate matching eliminates the need for rate conversion circuitry because the data signals pass directly from the die-to-die interface to the optical modulators without requiring multiplexing or demultiplexing operations. Because the clock is forwarded from the transmitter to the receiver on a dedicated wavelength channel, the receiver operates with a clock that is inherently synchronized to the transmitter timing. This synchronization removes the need for the gearbox circuitry and the CDR function that conventional systems employ to bridge timing mismatches between the recovered clock and downstream processing logic. Accordingly, the EIC 104 in the clock forwarding architecture may lack a gearbox configured to perform rate conversion between the processing unit and the PIC 102, and/or may lack clock and data recovery (CDR) circuitry for recovering a clock from the data stream.

Referring to FIG. 3B, a block diagram illustrates an example transmit path for an optical communication system with clock forwarding. In the transmit path, the XPU 108 is configured for UCIe 64 GT/s with forwarded clock (although different transfer rates are possible). The XPU 108 provides both data signals (DATA) and clock signals (CLK) directly to the EIC 104. The EIC 104 includes the SerDes 150 and modulator driver operating as a 64 Gbps NRZ amplifier that achieve 3 Vpp modulator voltage, for example. Unlike the clock recovery architecture, no CDR is required in the EIC 104, and no gearbox is required because the optical modulation rate matches the data rate of the XPU interface. The forwarded clock architecture may be designed so that the optical modulation rate equals the interface data rate (e.g., the 64 GT/s transfer rate in this example). The SerDes 150 provides the amplified signals to the PIC 102. The PIC 102 includes microring modulators (MRM) that modulates the data and clock onto respective optical wavelengths. The PIC 102 encodes a plurality of data channels using the data stream by modulating light having wavelengths defining a WDM grid, and encodes a clock channel using the clock signal by modulating light having a wavelength that is different from each of the wavelengths defining the WDM grid. The PIC 102 outputs a WDM signal with N+1 wavelengths, including λ₁ through λ_{N} for data and λ_{CLOCK} for the clock signal, for transmission through the fiber 170. The specific data rates, voltage levels, and number of wavelengths described herein are provided as examples, and the application is not limited in this respect.

Referring to FIG. 3C, a block diagram illustrates an example receive path for an optical communication system with clock forwarding. In the receive path, the PIC 102 receives a WDM input with N+1 wavelengths including λ₁ through λ_{N} and λ_{CLOCK} from the fiber 170. The PIC 102 includes detectors configured with WDM λₙ demultiplexer and photodetector with fiber input that perform WDM demultiplexing and photodetection to convert the optical signals to electrical signals. The PIC 102 extracts a data stream from the modulated light having wavelengths defining the WDM grid, and extracts a clock signal from the modulated light having the wavelength that is different from each of the wavelengths defining the WDM grid. The detectors provide photocurrent signals to a transimpedance amplifier (TIA) within the EIC 104. The TIA is configured as a 64 Gbps NRZ amplifier that converts the photocurrent to UCIe RX voltage of approximately 1 Vpp, for example. Unlike the clock recovery architecture, no CDR is required in the EIC 104 because the clock signal is received on a dedicated wavelength channel. The EIC 104 lacks clock and data recovery (CDR) circuitry for recovering a clock from the data stream, and lacks a gearbox configured to perform rate conversion between the PIC 102 and the processing unit. The signals and clock go directly to the TIA without requiring clock recovery from the data. The EIC 104 forwards the data stream and the clock signal to the XPU 108, which is co-packaged with the EIC 104. The SerDes 150 in the EIC 104 provides DATA and CLK signals to the XPU 108. The XPU 108 is configured for UCIe 64 GT/s with forwarded clock sampling, enabling synchronous operation between the transmitter and receiver. The forwarded clock architecture provides reduced deterministic jitter, better signal-to-noise ratio and bit error rate, less power consumption due to elimination of the gearbox, retimer, CDR, and associated circuitry, and lower latency because the multiplexing and CDR operations that introduce delay are no longer present. The specific configurations and data rates described herein are provided as examples, and the application is not limited in this respect.

The clock forwarding architecture may include active/standby clock switching for improved link reliability. In this configuration, the receiver includes monitoring circuitry that continuously evaluates the quality of the received clock signal, such as signal-to-noise ratio (SNR) or amplitude. If the SNR or amplitude associated with the primary clock wavelength degrades below a threshold, the receiver automatically switches to a backup clock wavelength. The backup clock wavelength may be transmitted simultaneously with the primary clock wavelength through the fiber 170, with the receiver selecting between the two based on signal quality metrics. This failover mechanism enables continued operation during clock channel degradation without requiring link re-initialization.

In some embodiments, the receiver may use both clock signals simultaneously rather than selecting one or the other. In a dual-clock averaging configuration, the receiver recovers clock signals from two different clock wavelengths and averages the phase of the two recovered clocks. This phase averaging further reduces jitter beyond what is achievable with a single forwarded clock, because uncorrelated noise components in the two clock channels tend to cancel when averaged. The dual-clock averaging approach is distinct from simple failover redundancy in that both clock channels actively contribute to the timing reference used for sampling the data signals.

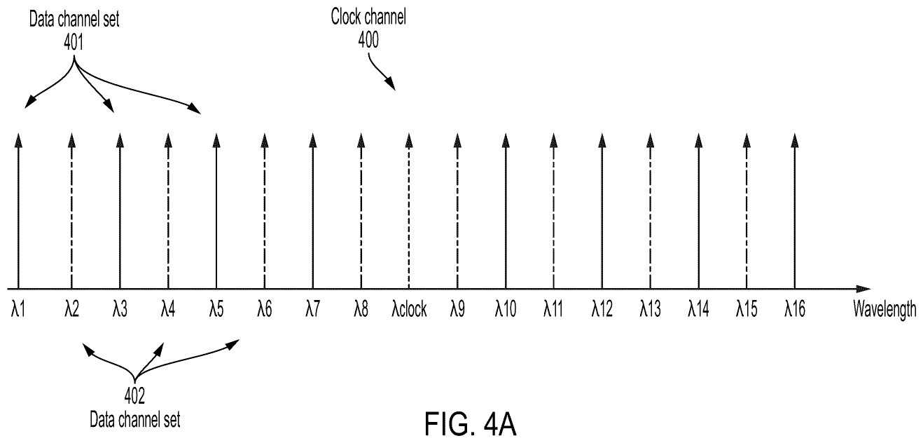

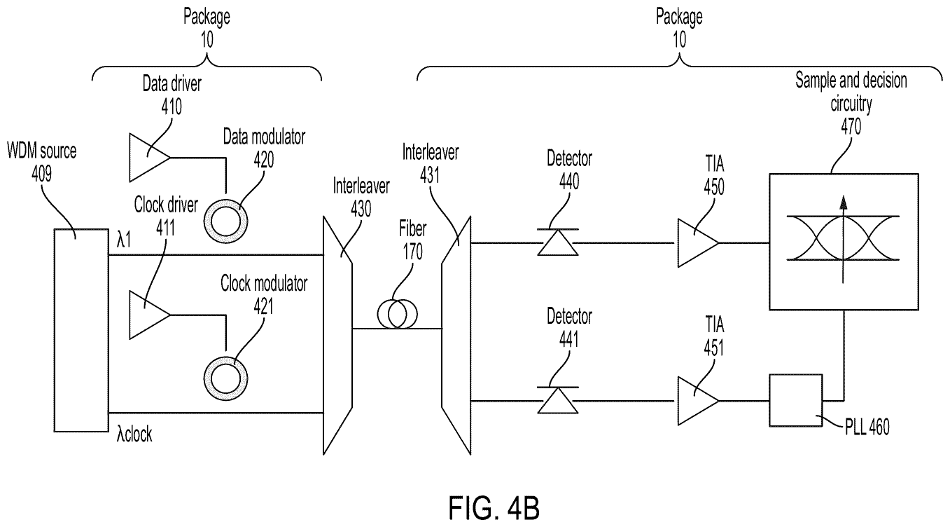

Referring to FIG. 4A, a wavelength diagram illustrates the spectral arrangement of data channels and a clock channel for a wavelength division multiplexing (WDM) optical communication system. The horizontal axis represents wavelength, with individual wavelengths labeled from λ₁ through λ₁₆, and an additional wavelength labeled λ_{clock} positioned between λ₈ and λ₉. A clock channel 400 is shown as a dashed vertical line at the λ_{clock} wavelength position, located at approximately the center of the wavelength grid (or more generally, between adjacent wavelengths of the WDM grid). The clock channel 400 carries the forwarded clock signal from the transmitter to the receiver through the fiber 170.

As further shown in FIG. 4A, a data channel set 401 includes multiple data channels shown as solid vertical lines positioned at wavelengths λ₁, λ₃, λ₅, λ₇, λ₉, λ₁₀, λ₁₂, λ₁₄, and λ₁₆. A data channel set 402 includes multiple data channels shown as solid vertical lines positioned at wavelengths λ₂, λ₄, λ₆, λ₈, λ₁₁, λ₁₃, and λ₁₅. The data channel set 401 and the data channel set 402 are interleaved across the wavelength spectrum, with alternating wavelengths assigned to each data channel set. This interleaved arrangement enables efficient use of the available optical spectrum while maintaining separation between adjacent channels within each bank.

Collectively, the data channel set 401 and the data channel set 402 define 16 channels with 400 GHz spacing between adjacent channels in a given channel set. When the data channel set 401 and the data channel set 402 are interleaved, the effective channel spacing is 200 GHz. This spectral arrangement provides high bandwidth density while maintaining adequate separation between adjacent channels to reduce crosstalk. The system may include two redundant clock wavelengths per fiber for clock resiliency, enabling continued operation if one clock wavelength experiences degradation or failure.

The clock channel 400 is positioned within the same communication band as the data channels to minimize differences in group velocity between the clock signal and the data signals. The clock wavelength may be transmitted in the O-band, C-band, or L-band, depending on the wavelength grid used for the data channels. By positioning the clock wavelength within the same band as the WDM grid, the propagation delay experienced by the clock signal closely matches the propagation delay experienced by the data signals as the signals traverse the fiber 170. Differences in group velocity between the clock channel 400 and the data channels would otherwise create unpredictable timing variations that degrade the temporal relationship between the clock and data at the receiver.

The clock channel 400 need not be positioned at the center of the wavelength grid. The clock wavelength may be positioned at other locations within the wavelength spectrum, provided that the clock wavelength remains within the same communication band as the data wavelengths. In some cases, the clock wavelength may be positioned no more than 1 THz away from the closest WDM data channel to maintain similar group velocity characteristics. This flexibility in clock wavelength placement enables the clock channel 400 to be positioned based on performance characteristics of the clock recovery circuitry or based on available wavelength slots within the WDM grid.

In some embodiments, a dedicated clock channel may be assigned to each data channel set. Referring again to FIG. 4A, the data channel set 401 and the data channel set 402 may each have an associated clock channel for independent timing domains. This per-bank clocking arrangement may be useful for skew management across wide WDM grids where the data channel sets are spectrally separated. For example, a first data channel set may be centered around 1311 nm while a second data channel set may be centered around 1331 nm. With such spectral separation, group velocity differences between the two data channel sets may introduce timing skew that a single clock channel may not adequately track.

The clock channel for each data channel set may be positioned at various locations within the respective bank. In some cases, the clock channel may be positioned at the center of the data channel set, such as at approximately 1311 nm for the first data channel set and at approximately 1331 nm for the second data channel set. Alternatively, the clock channel may be positioned at the shortest wavelength or the longest wavelength of each data channel set. When two clock channels are used per data channel set, one clock channel may be positioned at the shortest wavelength and another at the longest wavelength of the data channel set. The receiver may then average the phase of the two recovered clocks to provide a timing reference that accounts for group velocity variations across the spectral extent of the data channel set. This per-bank clocking with phase averaging enables precise timing alignment for each data channel set independently, which may be beneficial when the data channel sets operate in different timing domains or when the spectral separation between data channel sets is large enough to cause significant group delay differences.

Referring to FIG. 4B, a block diagram illustrates an optical communication system for chip-to-chip data transmission with a dedicated clock channel. The system includes a WDM source 409 that generates multiple wavelengths for data and clock transmission. The WDM source 409 outputs a first wavelength λ₁ for data transmission and a clock wavelength λ_{clock} for clock signal transmission. Additional data wavelengths corresponding to the data channel set 401 and the data channel set 402 may be generated by the WDM source 409, though these additional wavelengths are not shown in FIG. 4B. The WDM source 409 may include multiple laser sources operating at different wavelengths within the WDM grid, with each laser source providing optical power at a designated wavelength for either data transmission or clock transmission.

On the transmitter side, a data driver 410 provides the data signal to a data modulator 420. The data driver 410 may include a digital-to-analog converter and/or may be part of one of the SerDes 150 depicted in FIG. 3A. The data modulator 420 modulates the data onto the λ₁ wavelength received from the WDM source 409. The data modulator 420 may be implemented as a microring modulator (MRM), which uses a microring resonator to modulate the optical carrier based on the electrical data signal from the data driver 410. The data channel set 401 and the data channel set 402 may operate with an NRZ (non-return-to-zero) signaling for data transmission. Alternatively, PAM-x schemes (e.g., PAM-2, PAM-4 or PAM-8) may be employed.

As further shown in FIG. 4B, a clock driver 411 provides the clock signal to a clock modulator 421. The clock modulator 421 modulates the clock onto the λ_{clock} wavelength received from the WDM source 409. The clock modulator 421 may be implemented as a ring modulator similar to the data modulator 420. The ring modulator configuration for both the data modulator 420 and the clock modulator 421 enables compact integration within the PIC 102 while providing high-speed modulation capability for the data and clock signals.

The clock channel may use various modulation formats depending on system requirements. In some embodiments, the clock channel uses simple on-off keying (OOK) to produce a square wave clock signal. The square-wave clock provides sharper edges that may facilitate precise timing extraction at the receiver. Alternatively, the clock channel may transmit a sinusoidal tone rather than a square wave. A sinusoidal clock signal may be easier to filter and has lower bandwidth requirements compared to a square wave, which may reduce interference with adjacent data channels.

In some embodiments, the clock may be transmitted using differential clock encoding for improved signal integrity. In this configuration, the clock is transmitted on two wavelengths with complementary modulation, denoted as λ_{clock+} and λ_{clock-}. At the receiver, a balanced detector receives both clock wavelengths and rejects common-mode noise, improving the quality of the recovered clock signal. The tradeoff is that differential clock encoding consumes two wavelength slots instead of one and requires a pair of modulators at the transmitter and a balanced detector at the receiver. Alternatively, the two clock signals may be detected with individual detectors rather than a balanced detector, and common-mode noise rejection may be performed in the analog domain after detection.

The clock and data signals may be generated using microcomb laser technology. Microcomb lasers can generate many laser lines with precise frequency spacing, providing a convenient source for WDM systems. A single microring modulator (MRM) may be tuned to modulate one of the wavelengths generated by the microcomb. Alternatively, the free spectral range (FSR) of the MRM may be engineered to match the microcomb line spacing, enabling the MRM to modulate multiple wavelengths simultaneously. This may result in multiple clock signals in a single fiber, and the receiver may use the multiple clock signals to obtain a better timing reference through averaging or selection.

The clock and data signals may be modulated using various modulator technologies in addition to microring modulators. For example, thin-film lithium niobate (TFLN) modulators, indium phosphide (InP) modulators, or Mach-Zehnder modulators (MZMs) may be used to modulate the clock and data signals onto their respective wavelengths. The modulated signals may then be combined into a single fiber using a multiplexer or an interleaver.

The data and clock signals may travel on a single-mode (SM) fiber, and the polarization state of the signals may vary as the signals propagate through the fiber. To accommodate arbitrary polarization states at the receiver, each signal (clock or data) may be detected using a polarization-splitter rotator (PSR) combined with a dual detector arrangement. The PSR separates the incoming optical signal into two orthogonal polarization components (TE and TM), the TM component and is rotated to TE, and each component is detected by a respective photodetector. The outputs of the two photodetectors may be combined to recover the signal regardless of its polarization state at the fiber output. This polarization diversity receiver architecture ensures reliable detection of both clock and data signals even when the fiber introduces polarization rotation or when polarization mode dispersion causes the polarization state to vary with wavelength or time.

An interleaver 430 combines the modulated data wavelength from the data modulator 420 and the modulated clock wavelength from the clock modulator 421 onto the fiber 170 for transmission. The interleaver 430 interleaves the multiple wavelengths from the data channel set 401 and the data channel set 402 along with the clock channel 400 onto a single fiber 170. The interleaver 430 may have a free spectral range (FSR) of 400 GHz to accommodate the channel spacing of the WDM grid. The combined optical signal carrying both data wavelengths and the clock wavelength propagates through the fiber 170 to the receiver side of the optical communication system.

At the receiver side, an interleaver 431 separates the interleaved wavelengths back into individual channels. The interleaver 431 receives the combined optical signal from the fiber 170 and demultiplexes the wavelengths to direct each wavelength to the appropriate receiver circuitry. The interleaver 431 separates the data wavelengths from the clock wavelength, routing the data wavelengths to data detection circuitry and routing the clock wavelength to clock recovery circuitry.

The data wavelength is directed from the interleaver 431 to a detector 440. The detector 440 converts the optical data signal to an electrical signal through photodetection. The detector 440 may be implemented as a photodiode that generates a photocurrent proportional to the optical power of the received data signal. The electrical signal from the detector 440 is amplified by a transimpedance amplifier (TIA) 450, which converts the photocurrent from the detector 440 into a voltage signal suitable for downstream processing.

The amplified data signal from the TIA 450 is provided to sample and decision circuitry 470. The sample and decision circuitry 470 samples the incoming data signal at timing instants determined by the recovered clock from a PLL 460 and compares the sampled voltage levels against threshold values to make bit decisions. The sample and decision circuitry 470 may include a sampler that captures the analog voltage of the data signal at each clock edge and a slicer that determines whether the sampled value corresponds to a logic high or logic low state. For multi-level signaling schemes such as PAM-4, the sample and decision circuitry 470 may include multiple slicers with different threshold levels to distinguish between the multiple amplitude levels of the modulated signal. The sample and decision circuitry 470 may be integrated as part of EIC 104 or XPU 108.

The clock wavelength is directed from the interleaver 431 to a detector 441. The detector 441 converts the optical clock signal to an electrical signal through photodetection. The electrical signal from the detector 441 is amplified by a TIA 451. The amplified clock signal from the TIA 451 is provided to the PLL 460.

The PLL 460 recovers and conditions the clock signal received from the TIA 451. The PLL 460 provides the recovered clock to the sample and decision circuitry 470 to synchronize sampling of the data signal from the TIA 450. The sample and decision circuitry 470 samples the data signal at timing instants determined by the recovered clock from the PLL 460 and makes bit decisions based on the sampled values.

The receiver may include clock quality monitoring circuitry that continuously evaluates the received clock signal. The monitoring circuitry may measure various parameters of the clock signal, including amplitude, phase noise, and jitter. These quality metrics may be reported to the XPU 108 or to a link management controller for proactive link health monitoring. The monitoring circuitry enables detection of clock channel degradation before the degradation causes data errors, allowing the system to take corrective action such as switching to a backup clock wavelength or adjusting receiver parameters. The clock quality monitoring circuitry may also enable the active/standby clock switching mechanism by providing the signal quality measurements used to determine when to switch from a primary clock wavelength to a backup clock wavelength.

The clock forwarding architecture may include wavelength locking mechanisms for both the transmitter and the receiver to protect against thermal drifts. At the transmitter, the clock wavelength may be stabilized using a feedback loop that monitors the wavelength and adjusts the laser temperature or current to maintain the desired wavelength. At the receiver, the wavelength-selective elements such as the demultiplexer or microring resonator filters may be similarly stabilized to track the clock wavelength. This wavelength locking ensures that the clock channel remains aligned with the receiver filter passband over temperature variations, maintaining reliable clock recovery across operating conditions.

The clock forwarding architecture may include a clock-to-data skew calibration procedure to compensate for residual group delay differences between the clock channel and the data channels. During a startup calibration or periodic recalibration, the transmitter sends known data patterns on the data channels while transmitting the clock on the clock channel. The receiver measures the phase offset between the forwarded clock and the data channels by comparing the timing of the received data patterns against the recovered clock. Based on the measured phase offset, the receiver applies a digital or analog phase correction to align the sampling clock with the data signals. This calibration compensates for group delay differences that may arise from wavelength-dependent propagation characteristics in the fiber. The calibration may be performed at link initialization and may be repeated periodically or in response to detected timing drift.

The clock channel 400 may transmit a forwarded clock signal at a lower frequency than the data rate. Transmitting the clock at a lower frequency reduces power consumption of the clock driver 411 and the clock modulator 421 at the transmitter side. The lower-frequency clock signal also reduces the impact of rise time limitations on clock signal integrity. At the receiver side, the lower-frequency clock signal is up-converted by the PLL 460 to the data rate frequency using an injection-locked oscillator (ILO). The ILO receives the lower-frequency clock signal from the TIA 451 and generates an output clock at a higher frequency that is phase-locked to the injected clock signal. The ILO may be incorporated within the PLL 460 or may operate in conjunction with the PLL 460 to provide the up-converted clock to the sample and decision circuitry 470. For example, the clock channel 400 may transmit a forwarded clock signal at a sub-harmonic of the data rate, such as ½, ¼, or ⅛ of the data rate, where the divisor is an integer N. Transmitting the clock at a lower frequency reduces power consumption of the clock driver 411 and the clock modulator 421 at the transmitter side. At the receiver side, the lower-frequency clock signal is up-converted to the data rate frequency using the ILO or other frequency multiplier. Different sub-harmonic ratios provide different tradeoffs between power savings and phase noise, with lower clock frequencies providing greater power savings but potentially introducing more phase noise during frequency multiplication.

In some embodiments, the clock channel 400 may transmit a multi-tone clock signal including two or more sub-harmonic tones on the same clock wavelength. The receiver mixes the multiple tones to reconstruct the full-rate clock. This multi-tone approach provides robustness against narrowband interference, because interference affecting one tone does not necessarily affect the other tones. The reconstructed clock benefits from the redundancy provided by the multiple tones.

The clock frequency may be dynamically adjusted based on link conditions. For example, the system may switch from a full-rate clock to a half-rate clock when the link is operating at reduced bandwidth or in a power-saving mode. This adaptive clock rate enables the system to optimize power consumption based on current operating requirements while maintaining clock forwarding capability.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

As used herein, terms such as “above,” “below,” “over,” “under,” “adjacent,” “upper,” “top,” “lower,” “bottom,” “vertical,” “horizontal,” “lateral,” and similar positional or directional descriptors are used solely to describe the relative arrangement and orientation of features as illustrated in the drawings and are not intended to be limiting. Such terms do not require any particular orientation of the device in use, manufacture, or operation, and the described features may be oriented in any direction without departing from the scope of the present disclosure. Moreover, these terms are not intended to imply any absolute position, gravitational reference, or fixed spatial relationship, and components described as being positioned using positional or directional descriptors may be arranged in different relative positions, including inverted, rotated, or otherwise reoriented configurations, while still performing the same function in substantially the same way to achieve substantially the same result.

1. A package, comprising:
an electronic integrated circuit (EIC) configured to obtain, from an XPU co-packaged with the EIC, a data stream and a clock signal, wherein the XPU comprises a central processing unit (CPU), a graphics processing unit (GPU), a tensor processing unit (TPU) or an accelerator; and
a photonic integrated circuit (PIC), on which the EIC is mounted, configured to:
encode a plurality of data channels using the data stream obtained by the EIC from the XPU, wherein encoding the plurality of data channels comprises modulating light having wavelengths defining a wavelength division multiplexing (WDM) grid,
encode a clock channel using the clock signal obtained by the EIC from the XPU, wherein encoding the clock channel comprises modulating light having a wavelength that is different from each of the wavelengths defining the WDM grid,
transmit the modulated light having wavelengths defining the WDM grid through an optical fiber, and
transmit the modulated light having the wavelength different from each of the wavelengths defining the WDM grid through the optical fiber.

2. The package of claim 1, wherein the wavelength is positioned within a same communication band as the wavelengths defining the WDM grid.

3. The package of claim 2, wherein the wavelength is positioned between adjacent wavelengths of the WDM grid.

4. The package of claim 2, wherein the wavelength is positioned less than 1 THz away from the closest wavelength of the WDM grid.

5. The package of claim 1, wherein the data stream obtained by the EIC from the XPU has a transfer rate, and wherein modulating the light having wavelengths defining the WDM grid is performed at a modulation rate matching the transfer rate.

6. The package of claim 5, wherein the EIC lacks a gearbox configured to perform rate conversion between the XPU and the PIC.

7. The package of claim 1, wherein the XPU is coupled to the EIC through an I/O interface that conforms to a Universal Chiplet Interconnect Express (UCIe) protocol.

8. The package of claim 1, further comprising a substrate on which the PIC and the XPU are mounted, wherein the substrate comprises a silicon bridge coupling the PIC to the XPU.

9. A package, comprising:
a photonic integrated circuit (PIC) configured to:
receive, from an optical fiber, modulated light having wavelengths defining a wavelength division multiplexing (WDM) grid,
receive, from the optical fiber, modulated light having a wavelength that is different from each of the wavelengths defining the WDM grid,
extract a data stream from the modulated light having wavelengths defining the WDM grid, and
extract a clock signal from the modulated light having the wavelength that is different from each of the wavelengths defining the WDM grid; and
an electronic integrated circuit (EIC), mounted on the PIC, configured to:
forward the data stream to an XPU co-packaged with the EIC, wherein the XPU comprises a central processing unit (CPU), a graphics processing unit (GPU), a tensor processing unit (TPU) or an accelerator, and
forward the clock signal to the XPU.

10. The package of claim 9, wherein the EIC lacks clock and data recovery (CDR) circuitry for recovering a clock from the data stream.

11. The package of claim 9, wherein the wavelength is positioned within a same communication band as the wavelengths defining the WDM grid.

12. The package of claim 11, wherein the wavelength is positioned between adjacent wavelengths of the WDM grid.

13. The package of claim 11, wherein the wavelength is positioned less than 1 THz away from the closest wavelength of the WDM grid.

14. The package of claim 9, wherein the data stream forwarded to the XPU has a transfer rate, and wherein extracting the data stream from the modulated light is performed at a rate matching the transfer rate.

15. The package of claim 14, wherein the EIC lacks a gearbox configured to perform rate conversion between the PIC and the XPU.

16. The package of claim 9, wherein the XPU is coupled to the EIC through an I/O interface that conforms to a Universal Chiplet Interconnect Express (UCIe) protocol.

17. A method, comprising:
obtaining, by a first electronic integrated circuit (EIC), a data stream and a clock signal from a first XPU co-packaged with the first EIC, wherein the first XPU comprises a central processing unit (CPU), a graphics processing unit (GPU), a tensor processing unit (TPU) or an accelerator;
encoding, by a first photonic integrated circuit (PIC) on which the first EIC is mounted, a plurality of data channels using the data stream, wherein encoding the plurality of data channels comprises modulating light having wavelengths defining a wavelength division multiplexing (WDM) grid;
encoding, by the first PIC, a clock channel using the clock signal, wherein encoding the clock channel comprises modulating light having a wavelength that is different from each of the wavelengths defining the WDM grid;
transmitting, by the first PIC, the modulated light having wavelengths defining the WDM grid and the modulated light having the wavelength different from each of the wavelengths defining the WDM grid through an optical fiber;
receiving, by a second PIC, the modulated light having wavelengths defining the WDM grid and the modulated light having the wavelength different from each of the wavelengths defining the WDM grid from the optical fiber;
extracting, by the second PIC, the data stream from the modulated light having wavelengths defining the WDM grid;
extracting, by the second PIC, the clock signal from the modulated light having the wavelength different from each of the wavelengths defining the WDM grid;
forwarding, by a second EIC mounted on the second PIC, the data stream and the clock signal to a second XPU co-packaged with the second EIC, wherein the second XPU comprises a CPU, a GPU, a TPU or an accelerator; and
sampling, by the second XPU, the data stream using the clock signal.

18. The method of claim 17, wherein the wavelength is positioned within a same communication band as the wavelengths defining the WDM grid.

19. The method of claim 17, wherein the second EIC lacks clock and data recovery (CDR) circuitry for recovering a clock from the data stream.

20. The method of claim 17, wherein the data stream obtained by the first EIC from the first XPU has a transfer rate, and wherein modulating the light having wavelengths defining the WDM grid is performed at a modulation rate matching the transfer rate.
